(19) United States
(12) Patent Application Publication
(10) Pub. No.: US 2020/0013108 A1
(43) Pub. Date: Jan. 9, 2020

(54) SYSTEM FOR INGREDIENT BASED PAIRING RECOMMENDATIONS

(71) Applicant: AYATANA TECHNOLOGIES INC., Mont-Royal (CA)

(72) Inventors: Terence KAO, Mont-Royal (CA); Jerome COMBET-BLANC, Montreal (CA)

(21) Appl. No.: 16/503,722

(22) Filed: Jul. 5, 2019

Related U.S. Application Data
(60) Provisional application No. 62/694,618, filed on Jul. 6, 2018.
(60) Provisional application No. 62/755,712, filed on Nov. 5, 2018.

(51) Int. Cl. G06Q 30/06

(52) U.S. Cl. CPC G06Q 30/0631; G06Q 30/0641

(57) ABSTRACT

The present technology generally relates to a system and a method for providing an ingredient based pairing recommendation to a user. The method comprises receiving one or more contextual items from a personalized recommendations module; from the received contextual items, generating provisional pairing recommendations; receiving a list of food-related information from the user; ranking the provisional pairing recommendations based on the list of food-related items; and generating a pairing recommendation to the user based on the ranked provisional pairing recommendations.

### CROSS-REFERENCE TO RELATED APPLICATIONS

This application claims the benefit of U.S. Provisional Application No. 62/694,618, filed Jul. 6, 2018, and of U.S. Provisional Application No. 62/755,712, filed on Nov. 5, 2018, the disclosure of both of which is incorporated herein by reference in its entirety.

### TECHNICAL FIELD

The present technology generally relates to a system for generating ingredient based pairing recommendations.

### BACKGROUND

A recommendation system is a computer-implemented system that recommends items from a database of items. The recommendations are personalized to particular users based on information provided by the users. One common application for recommendation systems involves recommending products to online users. For example, online service providers and retailers recommend items (books, songs, movies, etc.) to their users, according to user specific criteria.

i) Content-Based Filtering Approach

One approach commonly used is content-based filtering where recommendations for a user are based on other items with similar properties. The content-based filtering approach analyses the description of items to find items that are similar to those that where purchased, searched or identified by the user in the past.

A content-based filtering approach requires a user profile consisting of his preferences and history which will be used to provide the likelihood that the user will desire to purchase some other item. This approach suffers from the cold-start problem where the user profile is not yet established. This is a problem especially if the user is not familiar with many of the items to be able to rate them for the purpose of building a profile. The Content-based filtering approach is therefore not adapted for new users that have no associated preferences or history. Moreover, the content-based filtering approach is not adapted for users that want to obtain suggestions that are not associated to their preferences or history.

Another issue with content-based filtering is its limited usefulness for recommending across content types. For example, a content-based recommendation system for music is not adapted to recommend another type of product, such as movies.

ii) Collaborative Filtering Approach

Another approach commonly used is the collaborative filtering approach where recommendations for a user are based on preferences of other similar users. The collaborative filtering approach considers a specific item liked by a user to recommend other items that were preferred by other users who liked the same specific item.

The collaborative filtering approach is not adapted for the cold-start situation when no or little information is available on the user.

In addition, the collaborative filtering approach suffers from the cold-start problem when no or little information is available on the item. Since the item has no rating, it will never be recommended.

Since collaborative filtering requires other similar users, the approach is not well suited for a user whose tastes do not consistently agree or disagree with other users.

The collaborative filtering approach is therefore not adapted for new users that have no associated preferences or history or that have tastes that differ from the majority of users. Moreover, the collaborative filtering approach is not adapted for providing items that are new or that have no associated ratings.

iii) Hybrid Filtering Approach

Another approach provides a hybrid filtering approach that combines collaborative filtering and content-based filtering. The hybrid filtering approach can address some of the shortcomings the two approaches when applied individually. However, it still does not completely solve the cold-start problem when the item is new or when there are no associated ratings.

Presented in FIG. 1 is another known approach to solve the cold-start problem which involves building lists of similar items from purchase histories of users. However, such an approach relies on the user previous purchase intentions and does not necessarily reflect the user current purchase intentions. Moreover, the approach presented in FIG. 1 cannot recommend items that are not related to the user previous purchase intentions and is unlikely to recommend unfamiliar items to the user.

There is thus a need in the field for an approach to solve the cold-start problem in order to generate relevant recommendations to users.

### SUMMARY OF TECHNOLOGY

According to various aspects, the present technology relates to a method for providing an ingredient based pairing recommendation to a user, the method comprising: receiving one or more contextual items from a personalized recommendations module; from the received contextual items, generating provisional pairing recommendations; receiving a list of food-related information from the user; ranking the provisional pairing recommendations based on the list of food-related items; and generating a pairing recommendation to the user based on the ranked provisional pairing recommendations.

According to various aspects, the present technology relates to a computing device comprising at least one device processor and at least one device memory, the at least one device processor for initiating performance of a method for providing an ingredient based pairing recommendation to a user as defined herein, wherein one or more acts of the method are performed on one or more network devices communicatively coupled to the computing device via at least one network connection.

### BRIEF DESCRIPTION OF THE DRAWINGS

Further features of the present technology will become apparent from the following detailed description, taken in combination with the appended drawings, in which:

FIG. 1 is a schematic representation of a recommendation system of the prior art.

FIGS. 2A-2C are schematic representations of the recommendation system according to one embodiment of the present disclosure as well as various functionalities thereof (FIGS. 2B-2C).

FIGS. 3A-3M are schematic representations of examples of graphical user interfaces of the recommendation system of FIGS. 2A-2C displayed on a mobile device.

FIGS. 4A-4D are schematic representations of the recommendation system according to another embodiment of the present disclosure (FIG. 4A) as well as various functionalities thereof (FIGS. 4B-4D).

FIGS. 5A-5B are schematic representations of further functionalities of the recommendation system as illustrated in FIGS. 4A-4D.

FIGS. 6A-6B are schematic representations of further functionalities of the recommendation system as illustrated in FIGS. 4A-4D.

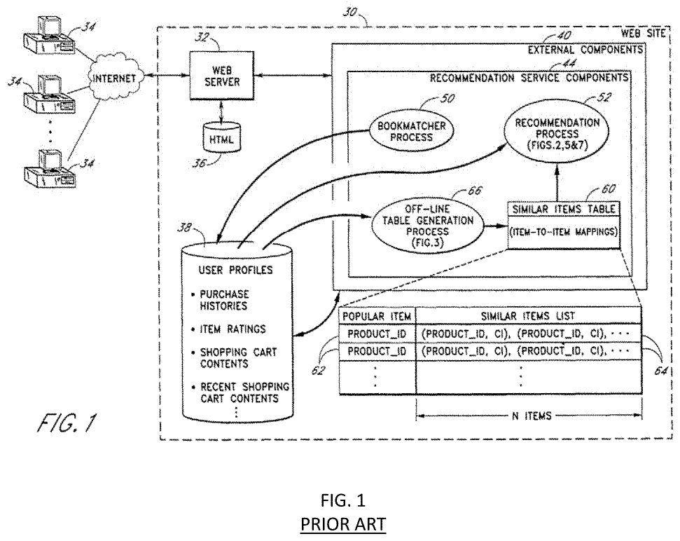

It will be noted that throughout the appended drawings, like features are identified by like reference numerals.

### DETAILED DESCRIPTION

Deciding what to eat when planning for grocery shopping is already a time consuming chore. Deciding what wine or beer to drink with the meal makes grocery shopping planning even more time consuming considering that there are thousands of choices of wine and beer. A system recommending a meal and a wine and/or a beer that pairs well with food can help users find quickly what to eat and/or drink when planning grocery shopping.

In one embodiment, the recommendation system of the present technology attempts to solve the cold-start problem using ingredients based recommendations such that a user can quickly input a few ingredients that he would like to use or eat or that he already has in his shopping cart or at home. Following his input, the user will be presented meal and wine or beer pairings.

The user can choose to add a pairing to his own mobile so that he has the detailed list of ingredients and recipe along with the paired wine or beer to add to his shopping cart. Personalized meal and wine or beer pairings can then be recommended to the user based on his meal, wine, beer and pairings preferences on his mobile.

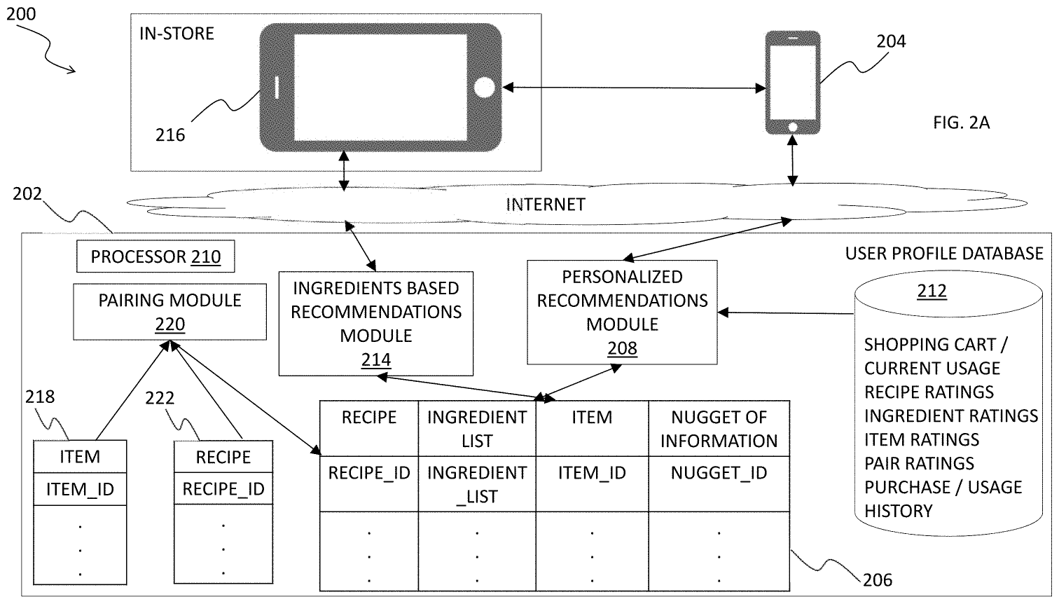

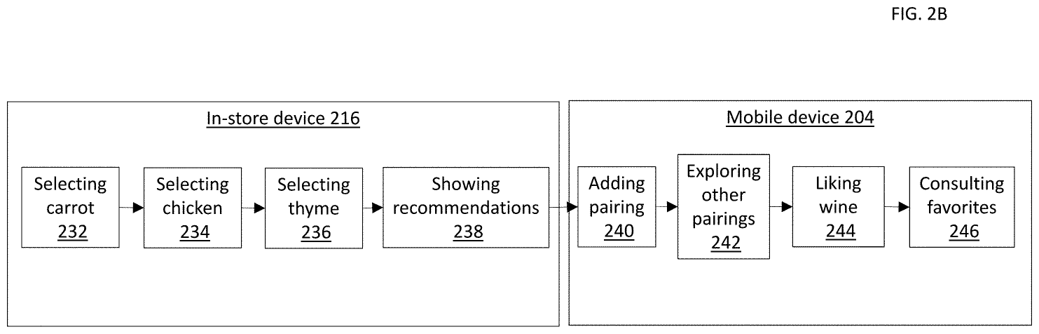

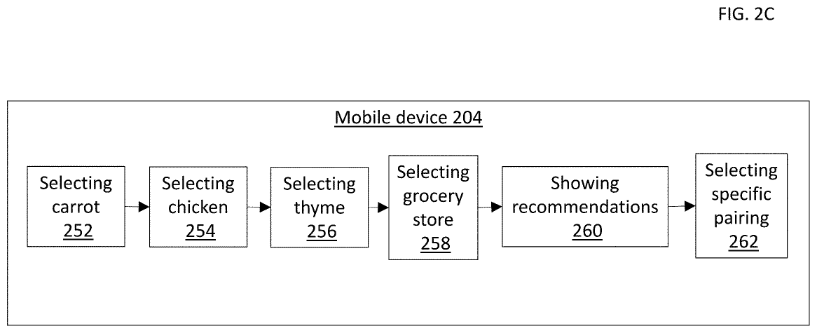

Presented in FIG. 2A is a system 200 for generating ingredient based pairing recommendations according to one embodiment of the present technology. The system 200 has a server 202 that is accessible by a mobile device 204 or by any other type of devices such as an in-store device 216 which could be connected to a network such as the Internet. The in-store device 216 may be populated with the ingredients offered by the store. The server 202 includes a pairing table 206 and a user profile database 212 that can be accessed by modules executable by a processor 210 such as a personalized recommendations module 208, an ingredients based recommendations module 214 and a pairing module 220.

The pairing table 206 is generated by the pairing module 220 based on elements the pairing module 220 obtains from an item table 218 and a recipe table 222. The recipe table 222 may be populated from any recipe databases available. The item table 218 is populated from information available in store (e.g., grocery store). In some implementations, the pairing module 220 generates a pairing table 206 that is specific to the store's offerings.

The recommendations by the ingredients based recommendations module 214 provided to the user in-store are shown on in-store device 216. The personalized recommendations provided by the personalized recommendations module 208 to the user on a personal mobile device are shown on a mobile device 204.

According to one embodiment, the pairing table 206 comprises recipes, ingredients, items and nuggets of information. Examples of nugget of information include, but are not limited to: a fun fact about an item or the pairing of the item with the recipe, a question and answer format, or the like. The nugget information could also combine information from the item table 218, information on the items from an external database and information from the pairing module 220.

According to one embodiment, the user profile database 212 has current shopping cart, recipe ratings, ingredient ratings, item ratings, pair ratings and purchase history. The current shopping cart and purchase history information can be populated from a combination of the user e-commerce, loyalty card and recommendation system utilization.

According to one embodiment, the items recommended are drinks such as wines, beers, coffees, teas, spirits or cocktails associated to a food element according to information provided by the user to educate the user on the pairing of the particular beverage and food. The user education on the pairing could be from the nugget of information.

According to another embodiment, the items recommended are cheeses associated to a food element according to information provided by the user.

According to another embodiment, the items recommended are restaurants associated to a food element according to information provided by the user.

According to another embodiment, the items recommended are physical activities such as cross-country skiing, snowshoeing, cycling, hiking, downhill skiing and snowboarding associated to a food element according to information provided by the user.

According to another embodiment, the in-store device 216 is the user's own mobile device presenting recommendations to the user based on his selection of ingredients.

According to one embodiment, the selection of ingredients on the user mobile is done using a voice recognition system capable of identifying the selected ingredients verbally indicated by the user.

According to another embodiment, the selection of ingredients on the user mobile is done using a chat bot system capable of identifying the selected ingredients written by the user.

According to another embodiment, the selection of ingredients on the user mobile is done by scanning the Quick Response (QR) code or barcode on the ingredients.

According to another embodiment, the in-store device 216 is an object detection system capable of detecting the ingredients that the user is handling or has selected and placed into his basket. Information associated to the selected ingredients is processed by the ingredients based recommendations module 214. The recommendations module 214 is adapted to provide personalized recommendations such as wine, beer and meal to the in-store device 216, according to the selected ingredients. The ingredients placed into a user's grocery basket would be captured by the object detection system in a similar way as with the in-store device 216. The personalized recommendations would be provided directly to the user on his personal mobile device without requiring him to use an in-store device or his personal mobile device to enter the ingredients.

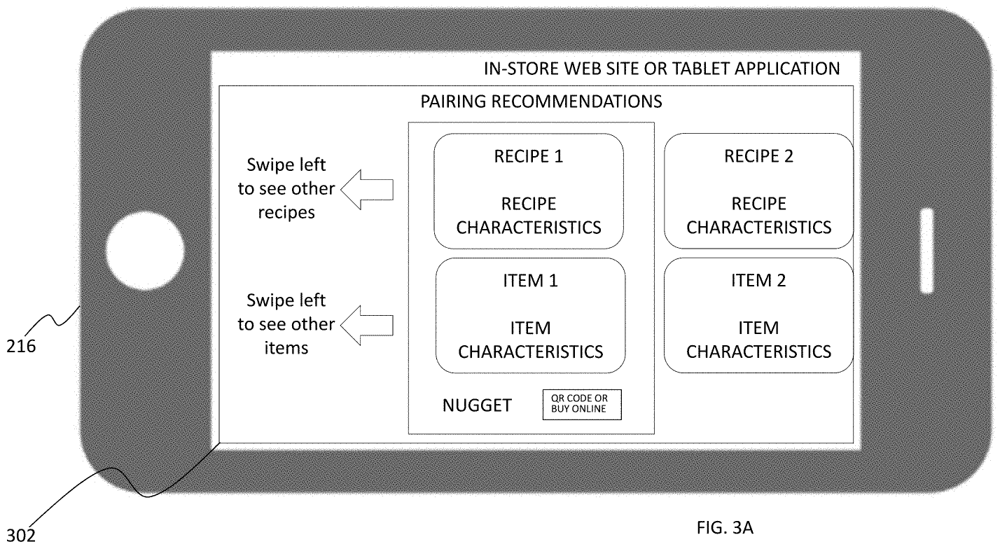

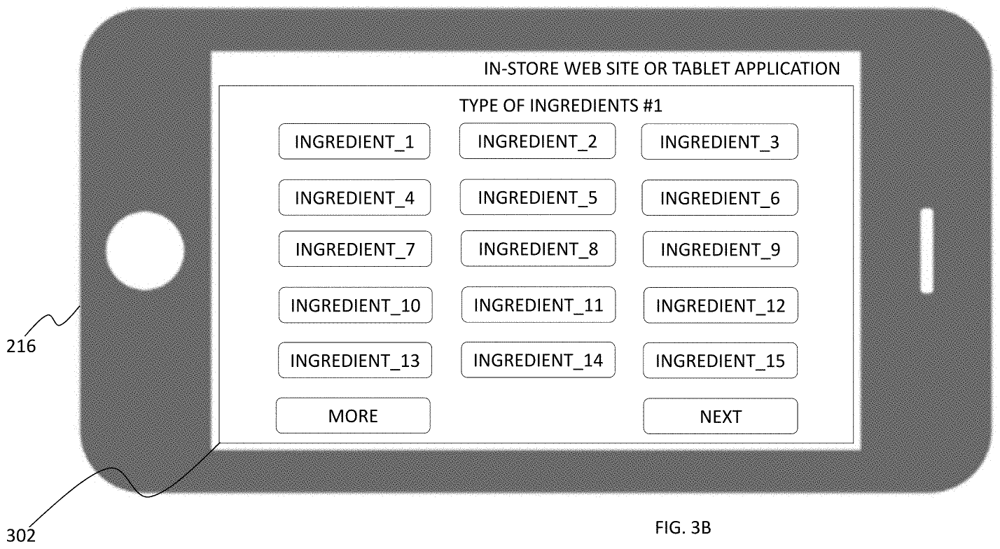

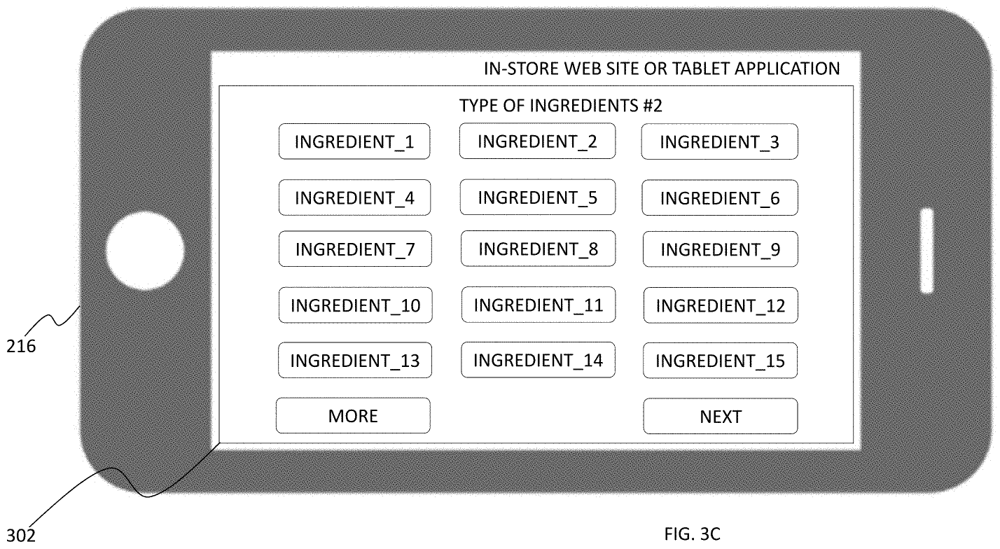

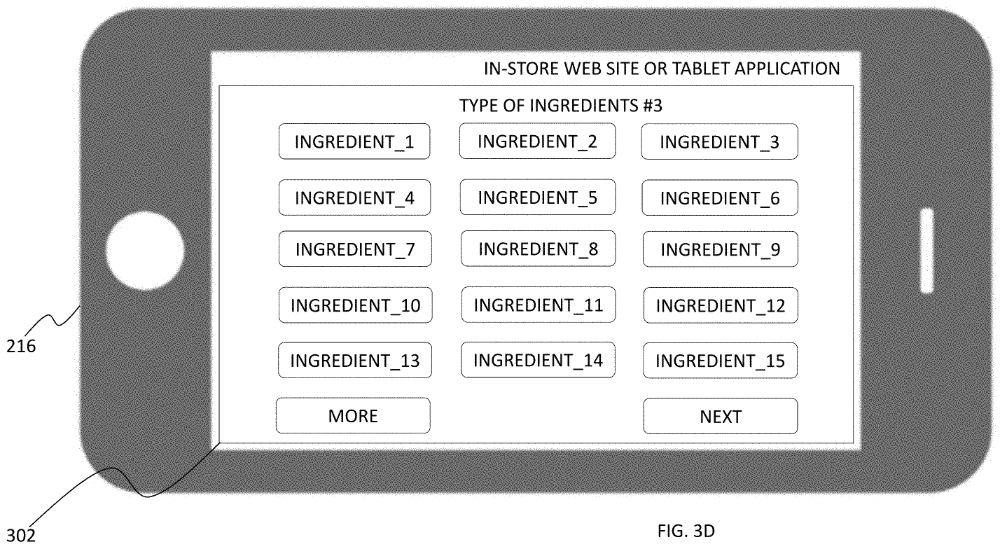

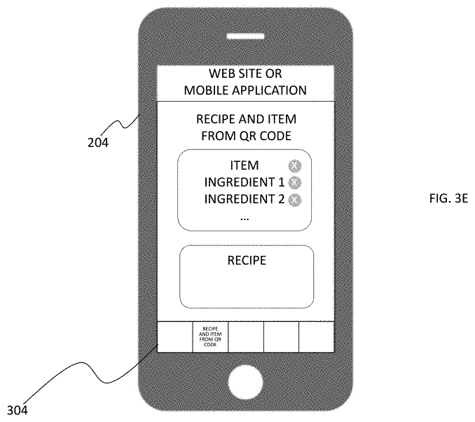

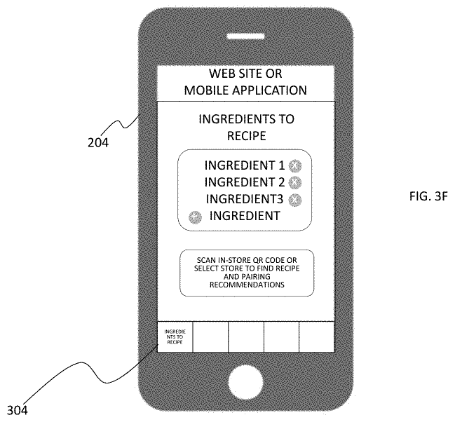

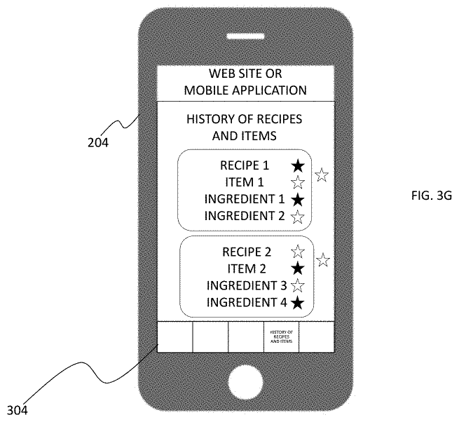

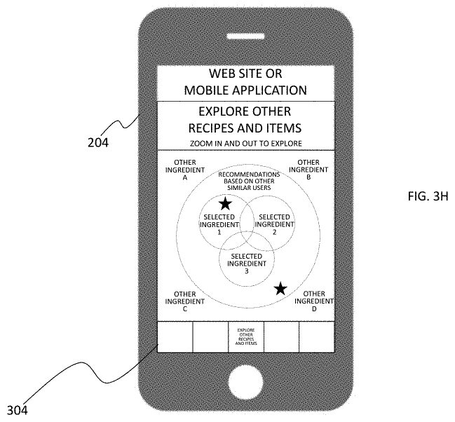

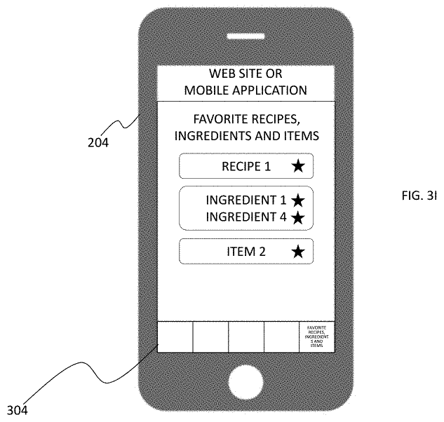

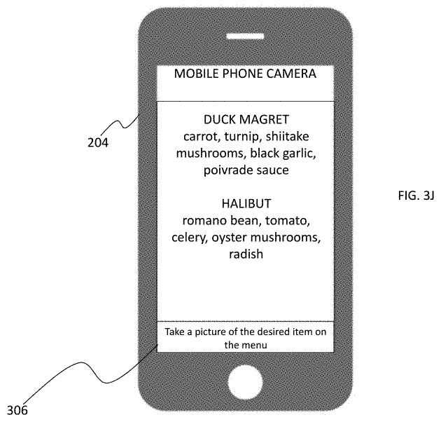

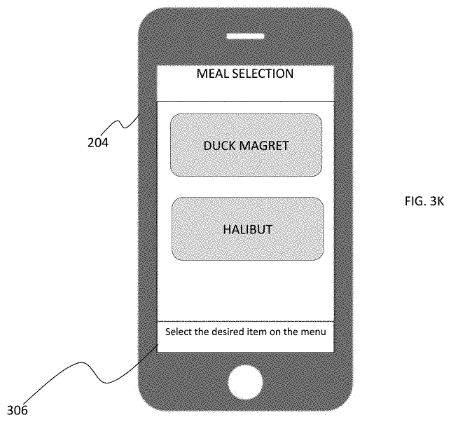

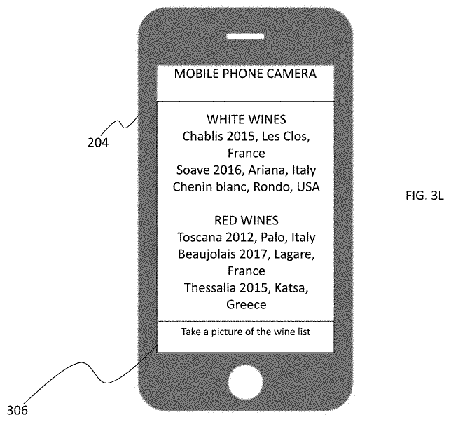

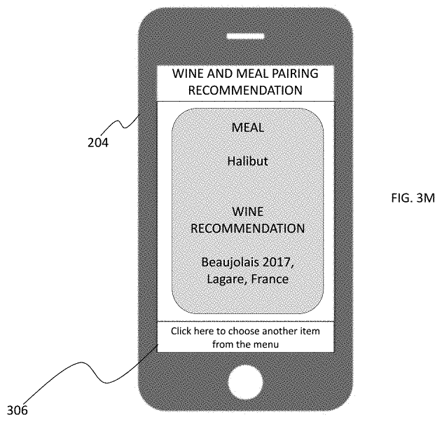

According to another embodiment, the selection of ingredients on the user mobile device is done using the mobile camera by taking a picture of the desired item in the menu of a restaurant. The items recommended are based on another picture of the desired list (wine list, beer list, etc.) of the restaurant. The pictures of the desired menu item and desired list can be taken either directly from the mobile device's camera or from a third-party mobile application. FIG. 3J shows how a user can take a picture of the desired item from the restaurant paper menu with the camera of his mobile device 306. FIG. 3K shows how a user can select the item on the menu if more than one item was recognized. FIG. 3L shows how a user can take a picture of the desired list. FIG. 3M shows the recommendations based on the selected menu item.

FIG. 2B shows a use case according to one embodiment of the present technology where a user starts on the in-store device 216 and selects carrot 232, chicken 234 and thyme 236 respectively as the first (FIG. 3B), second (FIG. 3C) and third (FIG. 3D) ingredients. The user is then shown pairing recommendations 238 (FIG. 3A) with recipes that include carrot, chicken and thyme and a wine that pairs well for each recipe. The user can add a pairing 240 to his mobile device 204 using the corresponding Quick Response (QR) code so that the user can consult the list of ingredients and wine to purchase (FIG. 3E). The user can also explore other pairings 242 based on the ingredients selected (FIG. 3H). The user can later go to his history of pairings and indicate 244 that he liked the wine (FIG. 3G). The user's favorites recipes, ingredients, wine and pairings are all stored so that the user can consult them 246 when needed (FIG. 3I).

FIG. 2C shows a use case according to another embodiment of the present technology where a user starts directly on his mobile device 204 and selects carrot 252, chicken 254 and thyme 256 respectively as the first, second and third ingredients (FIG. 3F). The user can then select a specific grocery store 258 and be shown pairing recommendations 260 (similar to FIG. 3A) with recipes that include carrot, chicken and thyme and a wine that pairs well for each recipe. The pairing recommendations will be based on items available at the specific store. The user can then select a specific pairing 262 and consult the list of ingredients and wine to purchase at the grocery store (similar to FIG. 3E).

According to another embodiment of FIG. 2C, the user selects the moment of the meal such as brunch and a type of food such as crepe before being shown recipes of crepe and drinks that go well with crepe.

According to another embodiment of FIG. 2C, the user selects a special occasion such as Father's day and an ingredient such as pineapple before being shown recipes with pineapple and cocktails that go well for a Father's day breakfast at home.

According to another embodiment of FIG. 2C, the user selects the city visited such as Seattle and a type of ingredient such as seafood before being shown local Seattle dishes and restaurants that serve them.

According to another embodiment of FIG. 2C, the user selects a location such as the Alpes, a physical activity such as downhill skiing and the moment of the meal such as dinner before being shown dishes that help recuperate after a day of skiing and restaurants in the Alpes that serve them.

Presented in FIG. 3A is the in-store device 216 having a user interface 302 displayed on the screen. The user interface provides educational recommendations. The user interface 302 has pairing recommendations where each pairing includes a recipe for a meal and an item. From the nugget, the user could learn fun facts about the items recommended or the reason behind the pairing of the item with the recipe. The user interface 302 is designed such that the user can swipe to see the other recommended pairings of meal and item. It shall be recognized that the user interface 302 could be provided by a web site of the store or by any other type of application such as a downloadable client application. The recommendations are indicative of a recommended recipe associated to an item according to information provided by the user such as a nugget of information. The nugget of information could be a short explanation of the pairing.

According to one embodiment, the recommendations are presented in order to educate the user on the pairing of the particular item and recipe and to let him explore other options of recipes and items. For example, a recipe with carrot, chicken and thyme could be paired with several similar wines in the same way that a specific wine could be paired with several recipes that include carrot, chicken and thyme. For example, a recipe with almond, chicken and thyme could be paired with light red wines such as a Pinot noir or a Beaujolais wine. The same Pinot noir wine could also be paired to a recipe comprising chicken, onion and basil.

According to one embodiment, the user interface 302 is shown on an in-store web site or with a client application and is adapted to present a Quick Response (QR) code associated to a selected recipe. The user can scan the Quick Response (QR) code to add the recipe, associated ingredients and item to his personal mobile device.

According to another embodiment, the user interface 302 is shown on an e-commerce web site or a client application and the user can directly buy the item and the ingredients of the recommended recipe online.

Presented in FIG. 3B, 3C and 3D is an example of a sequence of screens provided by the user interface 302 prior to presenting the recommendations. In this embodiment, the user is presented with three types of ingredients one after the other. For example, the first type of ingredient could be vegetables, the second type could be meat and the third type could be spices.

According to another embodiment, the user is presented with two types of ingredients followed by a type of cuisine.

Presented in FIG. 3E is a shopping basket interface 304 where the selected recipe, associated ingredients and item are added by scanning the QR code shown in FIG. 3A, according to one embodiment.

According to another embodiment, the user can buy the ingredients and item directly from the e-commerce web site or the client application.

Presented in FIG. 3F is the shopping basket interface 304 from which a grocery shopping list is created, according to one embodiment.

According to one embodiment, the user can from the basket interface 304 shown in FIG. 3F then go a store to scan a QR code to have personalized recommendations in a similar way as on the in-store application 302 as shown in FIG. 3A.

According to another embodiment, the user can from the screen shown in FIG. 3F then select the store of his choice to have personalized recommendations.

According to another embodiment, the store is selected automatically based on the geolocation of the user.

Presented in FIG. 3G is the application 304 on the user personal mobile device 204 where he can see his history of recipes, ingredients, items and pairings and can rate them.

Presented in FIG. 3H is the application 304 on the user personal mobile device 204 where he can explore other recipes and items based on his previously selected ingredients. The user can zoom in and out on recommendations based on all his selected ingredients, two of them or just one of them. The user can also explore other recipes and items based on other similar users and other ingredients that he did not select. The user can also explore based on his favorite recipes, ingredients and items shown with a filled star.

Presented in FIG. 3I is application 304 on the personal mobile device 204 of the user where he can see his favorite recipes, ingredients and items.

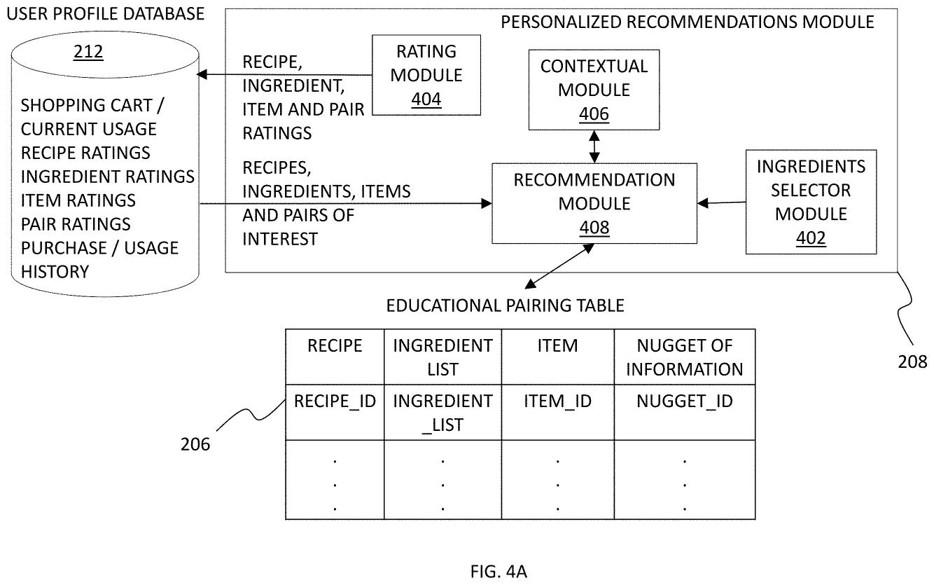

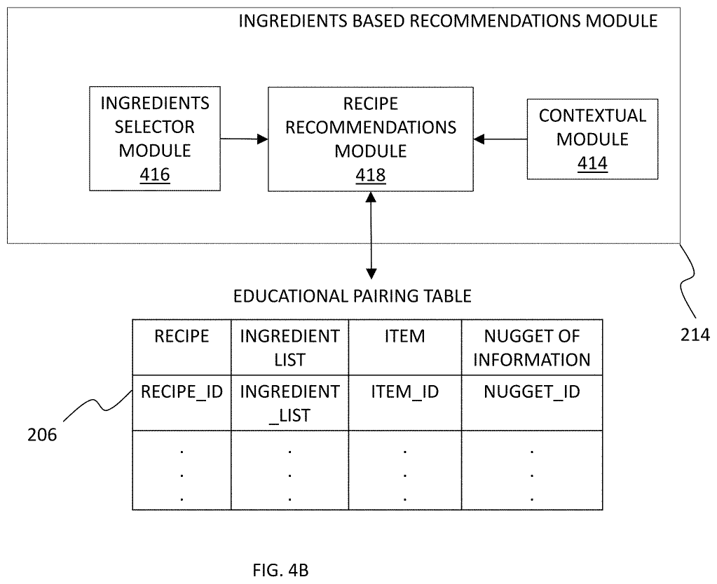

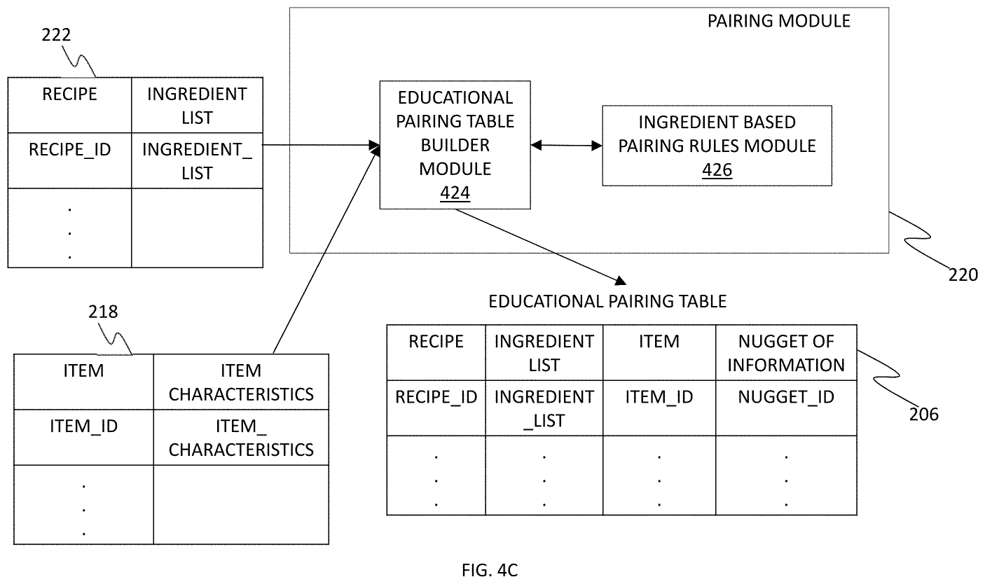

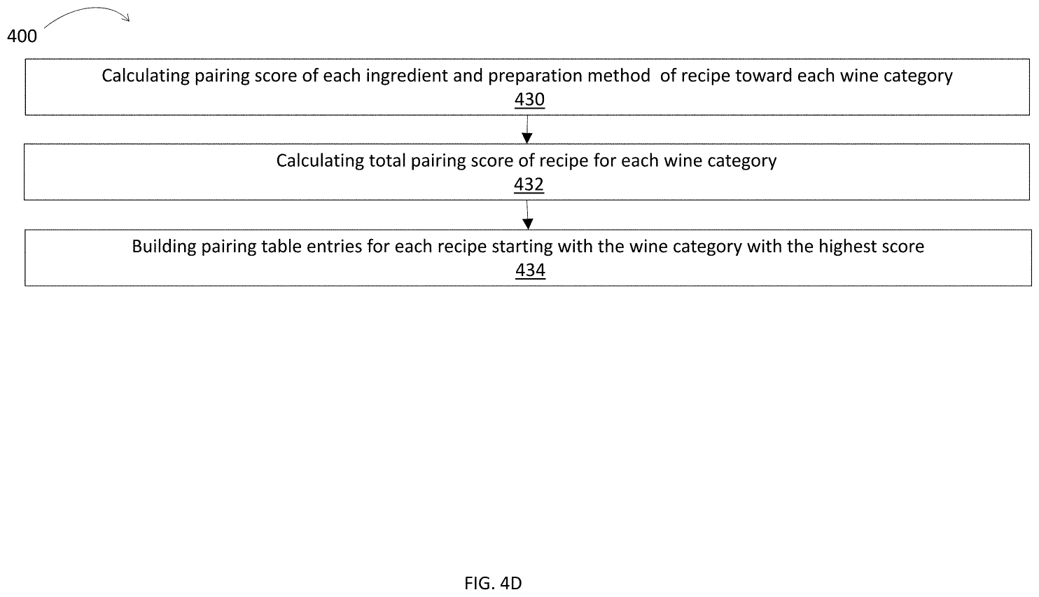

Presented in FIG. 4A is the personalized recommendations module 208 having several sub-modules. The module 208 includes an ingredients selector module 402, a rating module 404, a contextual module 406 and a recommendation module 408. The ingredients selector module 402 both displays the choices of ingredients to the user as well as it receives and stores the ingredients selected by the user via the user interfaces described in FIGS. 3B, 3C and 3D. The contextual module 406 is adapted to transfer a context of a recommendation request to the recommendation module 408. The context can specify a particular type of items (for example just wine or just beer) or all type of items. The rating module 404 is adapted to store in the database 212 a recipe, ingredient, item and pair ratings data associated to a user. A recipe, ingredient, item or pair can be rated positively simply by clicking on the star beside it as shown in FIG. 3G. The recommendation module 408 produces the user's specific recipe and item recommendations according to the ingredients selected, context of the recommendation request and ratings of recipe, ingredient, item and pair.

Presented in FIG. 4B is the ingredients based recommendations module 214 having several sub-modules. The ingredients based recommendations module 214 includes an ingredients selector module 416, a contextual module 414 and a recipe recommendations module 418. The ingredients selector module 416 takes the inputs from the user such as the sequence described in FIGS. 3B, 3C and 3D. The contextual module 406 is adapted to transfer a context of a recommendation request to the recommendation module 408. The recipe recommendations module 418 produces recipe and item recommendations according to the ingredients selected and context of the recommendation request.

Presented in FIG. 4C is the pairing module 220 having several sub-modules. The pairing module 220 includes an ingredient based pairing rules module 426 and an education pairing table builder module 424. The Recipe table 222 includes the recipe ID and ingredient list. The item table 218 includes the item ID and the item characteristics. The educational pairing table builder module applies the rules from the ingredient based pairing rules module 426 to the ingredients of each recipe and the characteristics of each item to produce the pairing table 206. According to one embodiment, the pairing rule module 426 comprises the specific pairing rules for wine. For example, the pairing rules for wine could define how each ingredient of a recipe and the preparation method (grilled, barbecued, fried, etc.) pairs with a certain category of wine.

Presented in FIG. 4D is a method of generating a wine pairing table 400 according to one embodiment. In this example, the wine pairing rules define a pairing score toward each category of wine for each ingredient in recipe and for the preparation method of recipe. The method includes calculating pairing score of each ingredient and preparation of recipe toward each wine category 430, calculating total pairing score of recipe for each wine category 432 and building pairing table entries for each recipe starting with the wine category with the highest score 434. For example, for recipe comprising roasted chicken, carrot and thyme, chicken is found to pair very well with rich white wine and light red wine and to pair well with medium red, rosé, light white and sparkling wines but does not pair well with bold red, sweet white and desert wines. The pairing score for chicken is therefore higher for rich white wine and light red wine than for all other wines. Carrot is found to pair very well with rosé wines and to pair well with rich white and sweet white wines. It does not pair with any other wines. The pairing score for carrot is therefore higher for rich white wine than all other wines. Thyme is found to pair very well with light white wines and well with medium red, light red, rosé and rich white wines but not the others. The pairing score for thyme is therefore higher for light white wine than all other wines. Roasted preparation is found to pair very well with bold red wine and well with medium red, light red, rosé and sweet white wines. Calculating the total pairing score of this recipe for each category would find the highest score for rosé wines since it pairs very well with carrot and it pairs well with chicken, thyme and roasted preparation.

According to one embodiment, the pairing rule module 426 comprises the specific pairing rules for beer. For example, the pairing rules for beer could define how each type of dish pairs with a certain beer style.

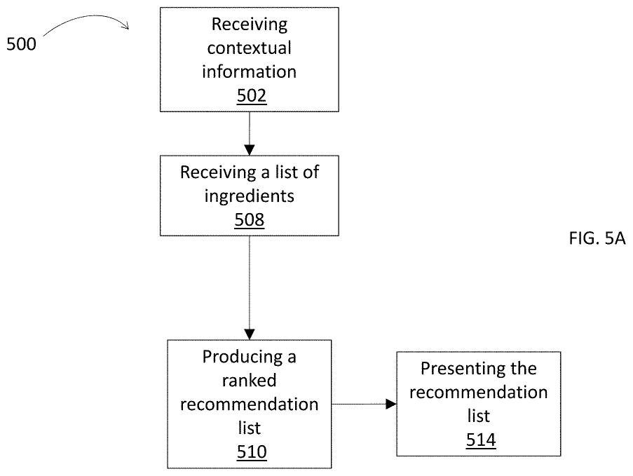

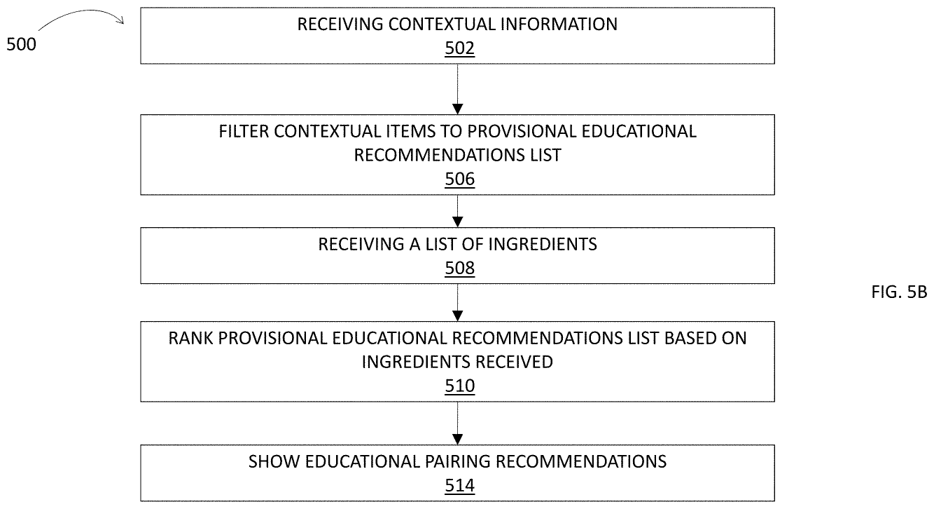

Presented in FIG. 5A, according to one embodiment, a user indicates with an in-store tablet 216 that he is interested in purchasing a bottle of wine for dinner. The user however does not really know what wine would be appropriate for the dinner. In his shopping cart, the user has already chosen several food items. The contextual module 414 receives contextual information 502 indicative of “a bottle of wine for dinner”. The ingredients selector module 416 receives the list of ingredients 508 entered by the user. The recipe recommendations module 418 uses the contextual information and the ingredients to produce a ranked recommendation list 510 based on the educational pairing table 206. Module 418 ranks the list such that recipes that include all ingredients entered by the user appear first. Recipes that have one ingredient missing appear second. Recipes that have only one ingredient appear last. The recommendation list of recipes and items is presented 514 as shown in FIG. 3A.

Presented in FIG. 5B is a method of providing ingredients based recipe and item recommendations 500 according to one embodiment. The method includes receiving a list of contextual items in 502, filtering the contextual items to a provisional educational recommendation list 506, receiving a list of ingredients entered by the user 508, ranking the provisional educational recommendation list based on the list of ingredients and finally showing the educational pairing recommendations 514. The provisional educational recommendation list is a subset of the pairing table 206 that comprises the requested items after 506 and ranked based on the selected ingredients after 510. It comprises all information on the recipe, ingredients, item and nugget of information.

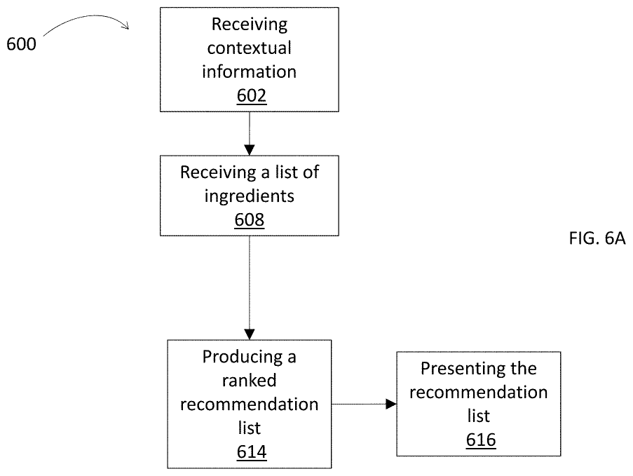

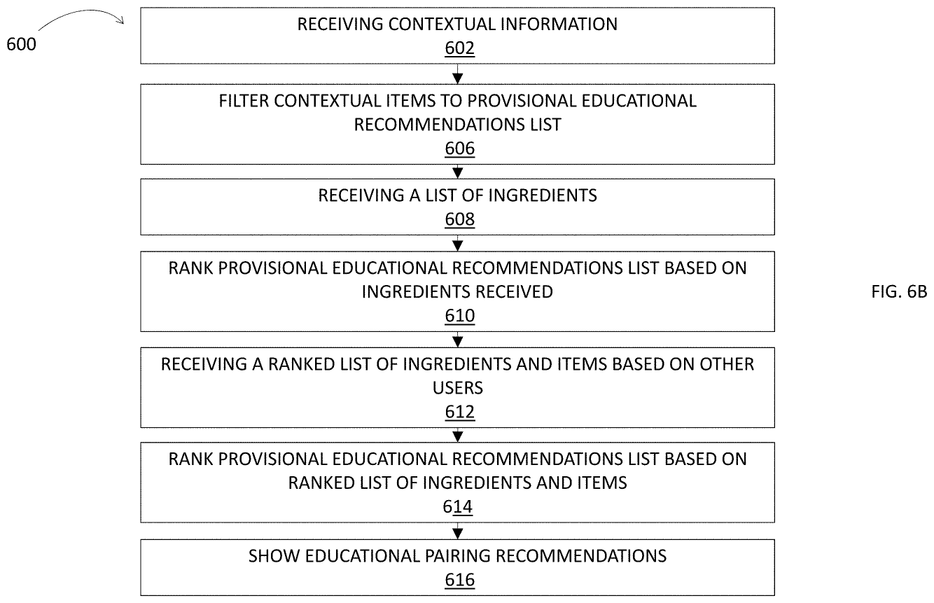

Presented in FIG. 6A, according to one embodiment, a user indicates with his personal mobile device that he is interested in purchasing a bottle of wine for dinner. The user however does not really know what wine would be appropriate for the dinner. In his shopping cart, he has already chosen several food elements such as shown in FIG. 3F. The contextual module 406 receives contextual information 602 indicative of “a bottle of wine for dinner”. The ingredients selector module 402 receives the list of ingredients 608 entered by the user. The recommendation module 408 uses the contextual information and the ingredients to produce a ranked recommendation list 610 based on the educational pairing table 206. The recommendation list of recipes and items is presented 614 as shown in FIG. 3A and 3H.

Presented in FIG. 6B is a method of providing user specific ingredients based recipe and item recommendations 600 according to one embodiment. The method includes receiving a list of contextual items in 602, filtering the contextual items to a provisional educational recommendation list 606, receiving a list of ingredients entered by the user 608 and ranking the provisional educational recommendation list based on the list of ingredients 610. This method continues by receiving a ranked list of ingredients and items based on other users 612 and ranking the provisional educational recommendations list to a final ranked list of recommendations 614. The final ranked list of recommendations is shown 616.

While the present technology has been described in connection with specific embodiments thereof, it will be understood that it is capable of further modifications and this application is intended to cover any variations, uses, or adaptations of the invention following, in general, the principles of the present technology and including such departures from the present disclosure as come within known or customary practice within the art to which the present technology pertains and as may be applied to the essential features hereinbefore set forth, and as follows in the scope of the appended claims.

1. A method for providing an ingredient based pairing recommendation to a user, the method comprising:
a) receiving one or more contextual items from a personalized recommendations module;
b) from the received contextual items, generating provisional pairing recommendations;
c) receiving a list of food-related information from the user;
d) ranking the provisional pairing recommendations of b) based on the list of food-related items of c); and
e) generating a pairing recommendation to the user based on the ranked provisional pairing recommendations.

2. The method according to claim 1, wherein c) further comprises receiving information about the user' s preferences and d) further comprises ranking the provisional pairing recommendations of b) based on the list of ingredients and on the user's preferences.

3. The method according to claim 1, wherein c) further comprises receiving information about other users' preferences and d) further comprises ranking the provisional pairing recommendations of b) based on the list of ingredients and on the other users' preferences.

4. The method according to claim 1, wherein the pairing recommendation is in relation to food and beverages.

5. The method according to claim 1, wherein step d) further comprises:
i) obtaining pairing score for each food items and preparation and beverage category ;
ii) obtaining total pairing score for recipe of each beverage category; and
iii) generating a pairing table for each recipe and beverage category.

6. The method according to claim 4, wherein the beverages is selected from beer, wine, tea, and liquor.

7. The method according to claim 1, wherein the personalized recommendations module comprises an ingredients selector module.

8. The method according to claim 7, wherein the ingredients selector module receives information about ingredients.

9. The method according to claim 1, wherein the personalized recommendations module comprises a rating module.

10. The method according to claim 1, wherein the personalized recommendations module comprises a contextual module.

11. The method according to claim 1, wherein the personalized recommendations module comprises a recommendation module.

12. The method according to claim 1, wherein the personalized recommendations module comprises information about the user's profile.

13. The method according to claim 1, wherein the pairing recommendation is generated by a pairing module.

14. The method according to claim 1, wherein the pairing recommendation is in relation to food elements and cheeses.

15. The method according to claim 1, wherein the pairing recommendation is in relation to restaurants food elements.

16. The method according to claim 1, wherein the pairing recommendation is in relation to physical activities and food elements.

17. A computing device comprising at least one device processor and at least one device memory, the at least one device processor for initiating performance of a method for providing an ingredient based pairing recommendation to a user according to claim 1, wherein one or more acts of the method are performed on one or more network devices communicatively coupled to the computing device via at least one network connection.
